(19) United States
(12) Patent Application Publication
(10) Pub. No.: US 2026/0010393 A1
(43) Pub. Date: Jan. 8, 2026

(54) APPARATUS AND METHOD WITH PROCESS MIGRATION

(71) Applicant: SAMSUNG ELECTRONICS CO., LTD., Suwon-si (KR)

(72) Inventors: Tian LIU, Xi'an (CN); Biao XING, Xi'an (CN); Fengtao XIE, Xi'an (CN)

(73) Assignee: SAMSUNG ELECTRONICS CO., LTD., Suwon-si (KR)

(21) Appl. No.: 19/258,371

(22) Filed: Jul. 2, 2025

(30) Foreign Application Priority Data
Jul. 2, 2024 (CN) 202410881769.2
Nov. 12, 2024 (KR) 10-2024-0160134

(51) Int. Cl. G06F 9/48; G06F 9/50

(52) U.S. Cl. CPC G06F 9/4856; G06F 9/5016

(57) ABSTRACT

A migration method includes: downgrading, by a source node, a physical page in a local memory corresponding to a process to a physical page of a compute express link (CXL) memory pool having a first physical address; reconstructing, by a target node, a first virtual address space as a second virtual address space; determining, by the target node, a second physical address of the physical page in the CXL memory pool; and mapping, by the target node, the second physical address to the second virtual address space, wherein the CXL memory pool is shared by the source node and the target node, the first physical address is based on a physical address encoding rule of the source node, and the second physical address is based on a physical address encoding rule of the target node.

### CROSS-REFERENCE TO RELATED APPLICATIONS

This application claims the benefit under 35 USC § 119(a) of Chinese Patent Application No. 202410881769.2 filed on Jul. 2, 2024, in the China National Intellectual Property Administration, and Korean Patent Application No. 10-2024-0160134 filed on Nov. 12, 2024, in the Korean Intellectual Property Office, the entire disclosures of which are incorporated herein by reference for all purposes.

### BACKGROUND

### 1. Field

The following description relates to an apparatus and method with the migration of a process.

### 2. Description of Related Art

High-performance computing (HPC) applications such as artificial intelligence (AI) applications require a large-scale computing system. Migration of a process generally involves moving the state of a running application from a source node to a target/remote node. The target node may need to continue to accurately run the application with minimal downtime during the moving. Migration technology may prevent load imbalances and performance bottlenecks by dynamically adjusting the location of tasks. Therefore, migration technology is beneficial in terms of the load balancing of a data center, improved defect tolerance, and high availability. Migration technology includes system-level migration technology (e.g., for migrating virtual machines) and process-level migration technology (e.g., for migrating containers).

System-level migration technology may first store the entire virtual memory of a source node or a container snapshot in a snapshot file and then may transmit the stored entire virtual memory or the stored container snapshot to a target node. The target node may need to read the transmitted entire virtual memory or the transmitted container snapshot for loading the same. Process-level migration technology may need to fully unload the state and data of a host and the data of a hardware accelerator for their transmission to the target node.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device is configured to perform at least part of migration of a process from a source node to a target node, the electronic device including: a memory storing instructions; and one or more processors configured to execute the instructions, wherein the instructions, when executed by the one or more processors, cause the electronic device to control: the source node to downgrade a physical page in a local memory corresponding to the process to a physical page of a compute express link (CXL) memory pool having a first physical address, the source node having a first virtual address space corresponding to the process; and the target node to reconstruct the first virtual address space as a second virtual address space, determine a second physical address of the physical page in the CXL memory pool and map the second physical address to the second virtual address space; wherein the CXL memory pool is shared by the source node and the target node, the first physical address is determined based on a physical address encoding rule of the source node, and the second physical address is determined based on a physical address encoding rule of the target node.

The instructions, when executed by the one or more processors, may cause the source node to identify the physical page of the local memory corresponding to virtual page of the source node based on a first page table indicating a correspondence between the virtual page of the source node and the physical page of the local memory of the source node.

Based on the control of the electronic device: the source node may transmit metadata including information on the first virtual address space to the target node, and the target node may reconstruct the first virtual address space as the second virtual address space based on the metadata received that the target node receives from the source node.

The second virtual address space may include a virtual page address dividing a virtual memory area of the target node and may not include physical page information on the target node.

Based on the control of the electronic device, the target node may reconstruct the second physical address based on information on the first physical address and the physical address encoding rule of the target node.

The information on the first physical address may include information on an offset corresponding to the first physical address of a physical page of the CXL memory pool.

Based on the control of the electronic device, the target node may map the second physical address to the second virtual address space by filling the second physical address into a second page table.

Based on the control of the electronic device, the target node may determine whether to upgrade a physical page of the CXL memory pool to a physical page of a local memory of the target node, based on a frequency of access to the physical page in the CXL memory pool.

Based on the control of the electronic device, the target node may upgrade the physical page in the CXL memory pool to the physical page of the local memory of the target node based on the frequency of access to the physical page in the CXL memory pool exceeding a threshold value.

In another general aspect, a migration method is performed by based on control of an electronic device, and the migration method includes, based on the control of the electronic device: downgrading, by a source node, a physical page in a local memory corresponding to a process to a physical page of a compute express link (CXL) memory pool having a first physical address, the source node having a first virtual address space corresponding to the process; reconstructing, by a target node, the first virtual address space as a second virtual address space; determining, by the target node, a second physical address of the physical page in the CXL memory pool; and mapping, by the target node, the second physical address to the second virtual address space, wherein the CXL memory pool is shared by the source node and the target node, the first physical address is based on a physical address encoding rule of the source node, and the second physical address is based on a physical address encoding rule of the target node.

The source node may identify the physical page of the local memory corresponding to a virtual page of the source node based on a first page table indicating a correspondence between the virtual page of the source node and the physical page of the local memory of the source node.

The migration method may further include: transmitting, by the source node, metadata including information on the first virtual address space to the target node, and the reconstructing the second virtual address space by the target node may be based on the metadata that the target node receives from the source node.

The second virtual address space may include a virtual page address dividing a virtual memory area of the target node and may not include physical page information on the target node.

The target node may reconstruct the first virtual address space as the second physical address based on information on the first physical address and the physical address encoding rule of the target node.

The information on the first physical address may include information on an offset corresponding to the first physical address of a physical page of the CXL memory pool.

The target node may map the second physical address to the second virtual address space by filling the second physical address into a second page table.

The target node may determine whether to upgrade a physical page of the CXL memory pool to a physical page of a local memory of the target node, based on a frequency of access to the physical page in the CXL memory pool.

The target node may upgrade the physical page in the CXL memory pool to the physical page of the local memory of the target node based on the frequency of access to the physical page in the CXL memory pool exceeding a threshold value.

The downgrading, by the source node, the physical page in the local memory corresponding to the process to the physical page of the compute express link (CXL) memory pool having the first physical address may comprise: moving the physical page from the local memory to the CXL memory pool.

A non-transitory computer-readable storage medium may store instructions that, when executed by a processor, cause the processor to perform any of the methods.

Other features and aspects will be apparent from the following detailed description, the drawings, and the claims.

### BRIEF DESCRIPTION OF THE DRAWINGS

FIG. 1 illustrates operations of a migration method according to one or more embodiments.

FIG. 2 illustrates downgrading a physical page of a source node to a physical page of a compute express link (CXL) memory pool, according to one or more embodiments.

FIG. 3 illustrates reconstructing a first virtual address space as second virtual address space, according to one or more embodiments.

FIG. 4 illustrates mapping a second physical address to a second virtual address space, according to one or more embodiments.

FIG. 5 illustrates upgrading a hot page or a cold page to a CXL memory pool, according to one or more embodiments.

FIG. 6 illustrates an architecture of process migration, according to one or more embodiments.

FIG. 7 illustrates a process migration device according to one or more embodiments.

FIG. 8 illustrates one or more electronic device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

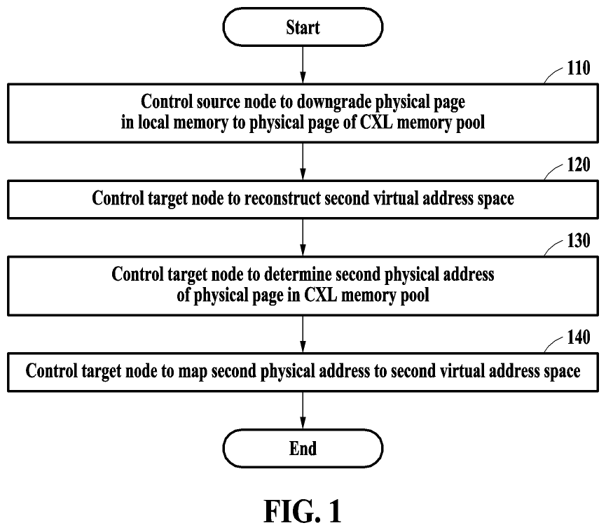

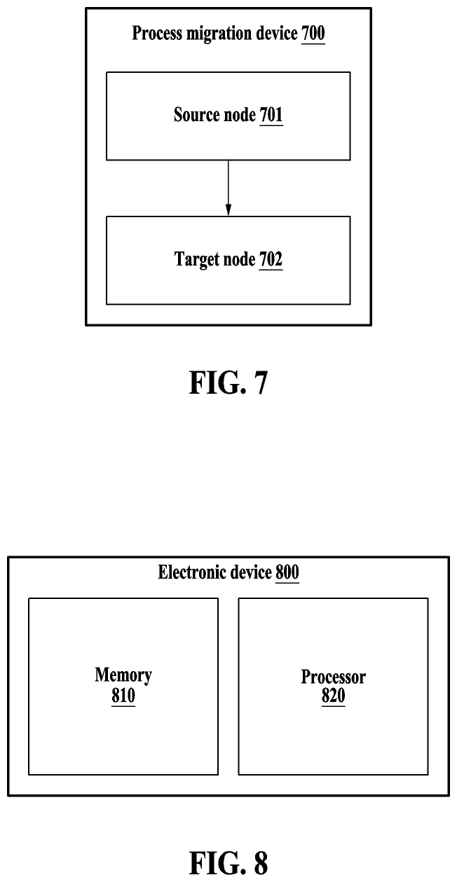

FIG. 1 illustrates operations of a migration method according to one or more embodiments. The operations of the migration method may be performed by an electronic device (e.g., an electronic device 800 of FIG. 8) or a process migration device (e.g., a process migration device 700 of FIG. 7) as described herein.

Referring to FIG. 1, in operation 110, the electronic device may control (e.g., signal) a source node to downgrade (migrate or move) a physical page in a local memory of the source node (e.g., a first local memory) to a physical page of a compute express link (CXL) memory pool. The nodes may be CXL nodes, as non-limiting examples. The downgraded physical page in the local memory may correspond to a process and the physical page of the CXL memory pool may have a first physical address. The first physical address may be based on a physical address encoding rule of the source node. The downgrading may involve (i) migrating data in the physical page in the first local memory into an unused physical page of the CXL memory pool and at the same time (ii) changing the physical page in the first local memory to an unused physical page.

Based on the control of the electronic device, the source node may identify the physical page of the local memory as corresponding to a virtual page of the source node based on a first page table. The first page table may indicate a correspondence between the virtual page of the source node and the physical page of the local memory.

The electronic device controlling the source node to downgrade the physical page may be triggered in response to the electronic device receiving a process migration request. The term “downgrading” has the same or similar meaning as “migration” and “moving”. The physical page in the first local memory may be used by a process executing in the source node.

In the first local memory, any given virtual page may or may not have a corresponding physical page. If a virtual page has a corresponding physical page, the virtual page is likely a page that is frequently accessed (frequently accessed pages generally being stored in a local memory) in the execution of its process. Such a virtual page may be referred to as a hot page. A frequently accessed virtual page (e.g., hot page) may be stored in the first local memory. If a virtual page does not currently have a corresponding physical page, the virtual page may generally be infrequently accessed the execution of a corresponding process. Such a virtual page may be referred to as a cold page. Whether a virtual page is a cold page or a hot page may be determined based on the frequency of access to the virtual page in the execution of a corresponding process. The CXL memory pool has a higher bandwidth and a lower latency input/output (I/O) latency and may be shared by all nodes. Although “hot” and “cold” are mentioned as being traits of virtual pages, the physical pages respectively associated with virtual pages may also be referred to as “hot” and “cold”.

In operation 120, based on control of the electronic device, a target node may reconstruct a first virtual address space (e.g., an address space corresponding to the process of the source node) as a second virtual address space.

Based on control of the electronic device, the source node may transmit metadata on the process and/or the first virtual address space to the target node. The metadata on the process and/or the first virtual address space may include information such as a start address (start_addr), size, permission, an access flag (access_flag), and/or an offset, of the first virtual address space. The target node may reconstruct first virtual address space as the second virtual address space based on the transmitted metadata. The second virtual address space may include a virtual page address dividing a virtual memory area of the target node and may not include physical page information on the target node.

In operation 130, based on control of the electronic device, the target node may determine a physical address of the physical page in the CXL memory pool (which will be referred to as a second physical address). The CXL memory pool may be shared by the source node and the target node. The second physical address may be determined based on a physical address encoding rule of the target node (described below).

The source node may have a physical address encoding rule for the first local memory and the CXL memory pool (the rule to be referred to as a first physical address encoding rule). The target node may have a physical address encoding rule for a local memory thereof (referred to as a second local memory) and the CXL memory pool (the rule to be referred to as a first physical address encoding rule). For example, the first local memory may include four storage units and the CXL memory pool may include 100 storage units. The source node may encode the physical address of the first local memory as 1, 2, 3, 4, and the physical address of the CXL memory pool as 5, 6, . . . , 104. The second local memory of the target node may include three storage units. The target node may encode the physical address of the second local memory as 1, 2, 3, and the physical address of the CXL memory pool as 4, 6, . . . , 103. The physical address in the source node for the same data in the CXL memory pool may be different from the physical address in the target node. The physical address encoding rule of the source node is different from the physical address encoding rule of the target node. Thus, a physical encoding address in the target node of the physical page downgraded to the CXL memory pool may be redetermined.

The electronic device may control the target node to reconstruct the first virtual address space as the second physical address based on information on the first physical address and the physical address encoding rule of the target node.

The information on the first physical address may include the first physical address and the first physical address encoding rule. The information on the first physical address may be used by the target node to determine information on the second physical address.

The information on the first physical address may include information on an offset corresponding to the first physical address of a physical page of the CXL memory pool. For example, based on the first physical address encoding rule, three physical page addresses of the CXL memory pool may be 5, 6, and 7, and addresses relative to the physical page addresses of the CXL memory pool may be 1, 2, and 3. Based on the relative addresses, the target node may encode three physical page addresses (e.g., the second physical address) in the CXL memory pool as 4, 5, and 6.

In operation 140, the electronic device may control the target node to map the second physical address to the second virtual address space. By mapping the second physical address to the second virtual address space, the process may continue to be executed in the target node. For example, the electronic device may control the target node to map the second physical address to the second virtual address space by filling the second physical address into a second page table.

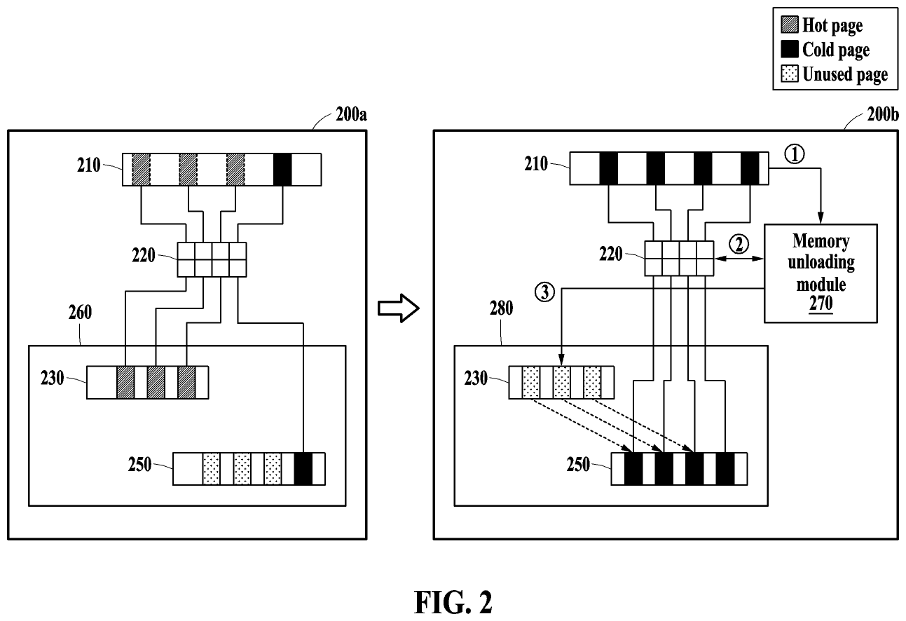

FIG. 2 illustrates downgrading a physical page of a source node to a physical page of a CXL memory pool, according to one or more embodiments.

Referring to FIG. 2, as an example, a first state 200a of a source node before a migration may include virtual pages 210 having three hot virtual pages and one cold virtual page, (ii) a page table 220, a local memory 230 including three hot physical pages (backing the three hot virtual pages), a CXL memory pool 250 having three unused pages and one cold page (backing the cold virtual page), and an initial physical memory layout 260, including the local memory 230 and the CXL memory pool 250.

A second state 200b of the source node may include the virtual pages 210 having four cold pages, the page table 220, the local memory 230 having three unused pages, the CXL memory pool 250 having one previous cold page and three cold pages obtained by downgrading three unused pages from the local memory 230, a physical memory layout 280 after unloading hot data including the local memory 230 and the CXL memory pool 250, and a memory unloading module 270.

The virtual pages 210 may be divisions of a virtual memory area/space. For example, the virtual pages 210 may be units of the virtual memory area, e.g., 4 KB basic memory units.

The page table 220 indicates correspondences between the virtual pages 210 and physical pages that back the virtual pages 210. For example, the page table 220 may indicate, among others, correspondences between the virtual pages 210 and the physical pages of the local memory 230, and/or correspondences between the virtual pages 210 and the physical pages of the CXL memory pool 250. In practice, the page table 220 may consist of multiple page tables.

An electronic device (e.g., the electronic device 800 of FIG. 8), for example a network or fabric controller, may cause the memory unloading module 270 to perform active hot data unloading such that the source node may perform downgrading/migrating (here, the unloaded hot data is data that was hot but has become cold). In the example of FIG. 2, in the first state 200a, the virtual pages 210 have three hot pages and one cold page. The first state 200a may be changed to the second state 200b of the virtual pages 210 having four cold pages. Specifically, based on the control of the electronic device, in operation \textcircled{1}, the source node may obtain the four cold virtual pages 210 by dividing the virtual memory area. In operation \textcircled{2}, the source node may reference the page table 220 to determine the four physical pages in the local memory 230 (e.g., a local dynamic random access memory (DRAM)) that correspond to (or back) the four virtual pages 210. In operation \textcircled{3}, the memory unloading module 270 may downgrade (migrate) hot data included in the hot pages in the local memory 230 to the CXL memory pool 250. Based on the control of the electronic device, the source node may automatically downgrade cold pages in the local memory 230 (which become unused pages) to respective physical pages in the CXL memory pool 250. To be clear, “hot data” refers to data included in a hot page and “cold data” refers to data included in a cold page.

During the execution of a process, access to hot data may diminish and the hot data may become cold data (as shown in FIG. 2), or access to cold data may increase and the cold data may become hot data. When hot data in the local memory 230 becomes cold data, based on control of the electronic device, the source node may downgrade/move the cold data from the local memory 230 to the CXL memory pool 250 (the cold data becoming unused page(s), as shown in the local memory in the second state 200b in FIG. 2). The now-unused physical pages in the local memory 230 may be used to store other hot data. If downgrading has been performed, the amount of movement of data from the local memory 230 to the CXL memory pool 250 upon a process or system migration from the source node may be reduced, since cold data has been pre-positioned into the CXL memory pool 250.

Data in a physical page in the local memory 230 may have already been changed to cold data. If cold data has not been migrated into the CXL memory pool 250 before a process system migration, the cold data may need to be downgraded to the CXL memory pool 250 when the process or system migration starts, which may slow the migration process. When cold data is migrated into the CXL memory pool 250 before process/system migration starts, memory downgrading may not need to be performed on the cold data when the process/system migration begins.

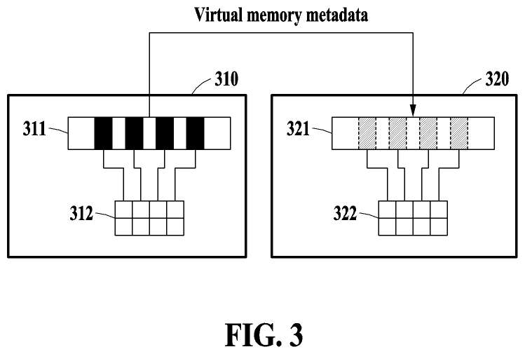

FIG. 3 illustrates reconstructing a first virtual address space as a second virtual address space, according to one or more embodiments.

Referring to FIG. 3, an electronic device (e.g., the electronic device 800 of FIG. 8) may signal or control a source node 310 to transmit metadata to a target node 320 in relation to a migration. The metadata may include information on a first virtual address space 311. For example, the metadata may be virtual memory metadata that includes information on the first virtual address space 311 on virtual pages included in the source node 310 (or a virtual address space that includes the virtual pages 210). The information on the first virtual address space 311 may include information on a physical address space of a physical page of a CXL memory pool and/or a local memory (e.g., a first local memory) of the source node 310 on a first page table 312. In short, the metadata may include any information that facilitates reconstruction of the first virtual address space 311.

The electronic device may control/signal the target node 320 to reconstruct the first virtual address space 311 as a second virtual address space 321 based on the metadata received from the source node 310. For example, based on the control/signal of the electronic device, the target node 320 may construct the second virtual address space 321 by cloning the first virtual address space 311 based on the received metadata. The second virtual address space 321, to which a physical page has not yet been allocated, may include virtual memory information.

Further based on the control of the electronic device, the target node 320 may configure a second page table 322 (e.g., a page table in the target node 320) while configuring the second virtual address space 321. The filled second page table 322 may store associations between virtual addresses in the second virtual address space 321 and physical addresses in the local memory of the target node 320 and/or of physical addresses of physical pages in the CXL memory pool.

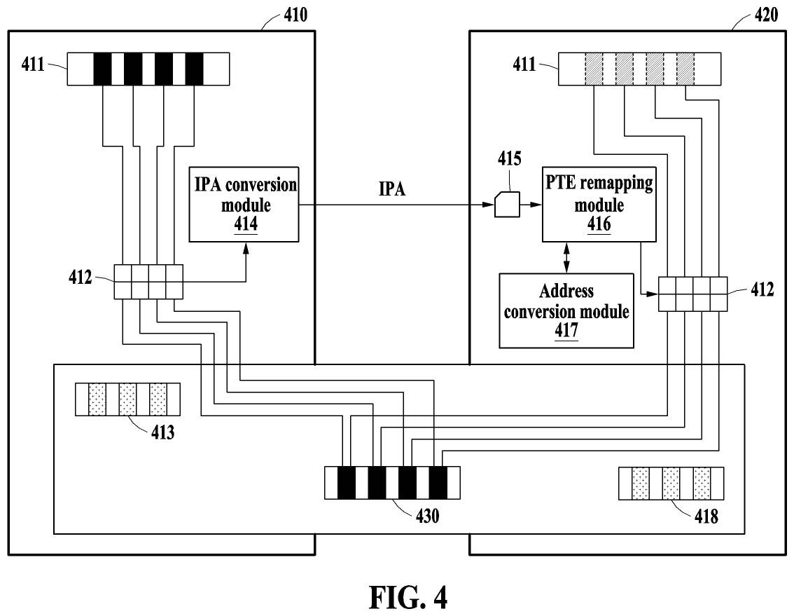

FIG. 4 illustrates mapping a second physical address to a second virtual address space, according to one or more embodiments.

Referring to FIG. 4, an electronic device (e.g., the electronic device 800 of FIG. 8) may control a source node 410 to map the second physical address to the second virtual address space based on three steps.

In the first step, based on the control of the electronic device, the source node 410 may obtain an intermediate physical address (IPA) (e.g., information on a first physical address) by using an IPA conversion module 414 and may transmit the IPA to a target node 420. The IPA may also be referred to as a relative address (e.g., a kind of offset). The IPA, and a physical address before being converted by the IPA conversion module 414, may correspond to virtual addresses (VAs) of a VA space 411 (e.g., virtual address space 311) of the source node 410 on a second page table 412 (e.g., first page table 312).

In the second step, based on the control of the electronic device, the target node 420 may obtain an IPA by using a page table entry (PTE) remapping module 416 and obtain the second physical address by using an address conversion module 417. The target node 420 may obtain the IPA by using the PTE remapping module 416 and a new physical address (e.g., the second physical address) based on physical memory information 415 of the target node 420 by using the address conversion module 417.

In the third step, based on the control of the electronic device, the target node 420 may fill/insert the second physical address in a page table (e.g., the second page table 412) configured by the target node 420 by using the PTE remapping module 416. The second page table 412 configured by the target node 420 may indicate correspondences (or store associations) between virtual pages included in the VA space 411 of the target node 420 and physical pages in a CXL memory pool 430 (and possibly later, after migration, associations with physical pages in a second local memory 418 and the virtual pages of the VA space 411).

A physical page in the CXL memory pool 430 may be directly injected into the VA space 411, which includes virtual pages of a migration process. Thus, when the migration process is executed, the target node 420 may not need to upgrade the physical pages in the CXL memory pool 430 to physical pages of a local memory (e.g., the second local memory 418) of the target node 420, since those pages are already backing virtual pages in the VA space 411 due to the previous updating of the second page table 412. When migration is performed, data in the CXL memory pool need not be loaded into the local memory of the target node 420. Thus, a data movement amount when a migration is initiated may be reduced. In addition, a cold page in a local memory (e.g., a first local memory 413) included in the source node 410 may be downgraded. Thus, data movement amount from the local memory to the CXL memory pool when migration begins may be reduced.

Based on the control of the electronic device, after a migration is complete and the migrated data is actively being used by the migrated system/process/etc. on the target node 420, the target node 420 may determine whether to upgrade a physical page in the CXL memory pool 430 to a physical page of the local memory of the target node 420, based on the frequency of access to the physical page 430 in the CXL memory pool. The electronic device may control the target node 420 to upgrade the physical page 430 in the CXL memory pool to a physical page of the local memory of the target node 420 when the frequency of access to the physical page 430 in the CXL memory pool exceeds a threshold value.

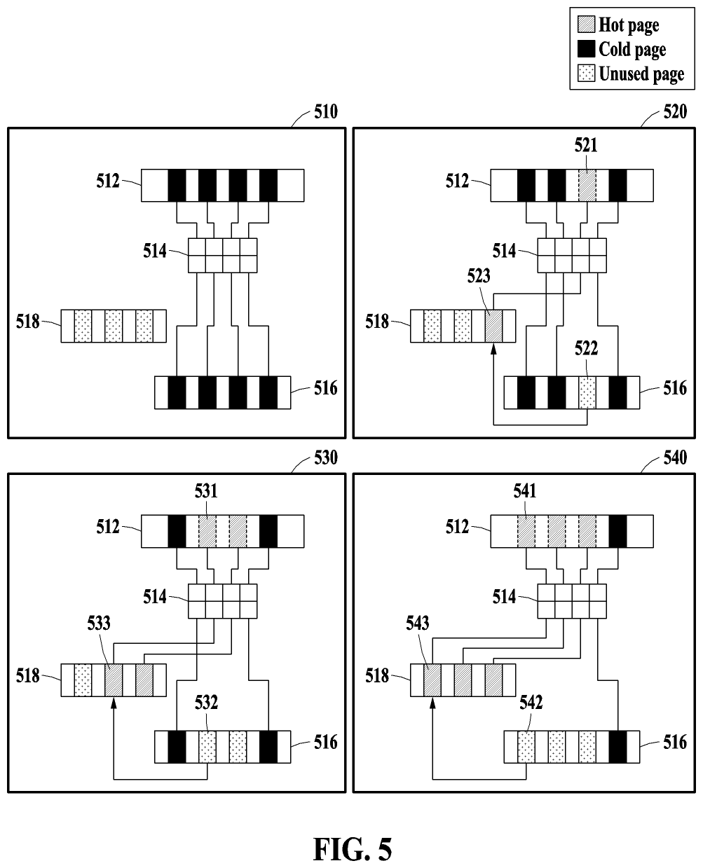

FIG. 5 illustrates upgrading a hot page or a cold page to a CXL memory pool, according to one or more embodiments.

Referring to FIG. 5, all data may be included in physical pages 516 in the CXL memory pool. If physical pages 516 in the CXL memory pool subsequently change to hot pages, they may be upgraded to physical pages of a local memory 518 (e.g., the first local memory 413 of the source node 410 of FIG. 4 or the second local memory 418 of the target node 420 of FIG. 4) of a corresponding node (e.g., a source node (e.g., the source node 410 of FIG. 4)) before migration or a target node (e.g., the target node 420 of FIG. 4) after migration). In this way, even after a migration to a target node, the target node may be preparing to act efficiently as a source node of a next migration.

In state 510, for example right after a migration completes (or possibly even as one is in progress) virtual pages 512 may include only cold pages. A page table 514 may indicate that all of the physical pages 514 corresponding to the virtual pages 512 are in the CXL memory pool, and the physical pages of the local memory 518 may all be unused pages.

In state 520, the virtual pages 512 may include a first hot page 521. Possibly based on control of an electronic device (e.g., the electronic device 800 of FIG. 8), the source node or the target node may upgrade the data of a physical page in the CXL memory pool, corresponding to the first hot page 521 included in the virtual pages 512, to a physical page, corresponding to the first hot page 521 included in the virtual pages 512, of the local memory 518, based on the page table 514. The physical page 523 of the local memory 518 after the upgrade may be a hot page, and the physical page 522 in the CXL memory pool after the upgrade may be an unused (free) page.

In state 530, the virtual pages 512 may include a second hot page 531. The source node or the target node may upgrade the data of a physical page in the CXL memory pool, corresponding to the second hot page 531 included in the virtual pages 512, to a physical page corresponding to the second hot page 531, of the local memory 518, based on the page table 514. The physical page 533 of the local memory 518 after the upgrade may be a hot page, and the physical page 532 in the CXL memory pool after the upgrade may be an unused (free) page.

In state 540, the virtual pages 512 may include a third hot page 541. The electronic device may cause the source node or the target node to upgrade the data of a physical page, corresponding to the third hot page 541 included in the virtual pages 512, in the CXL memory pool to a physical page, corresponding to the third hot page 541 included in the virtual pages 512, of the local memory 518, based on the page table 514. A physical page 543 of the local memory 518 after the upgrade may be a hot page, and a physical page 542 in the CXL memory pool after the upgrade may be an unused (free) page.

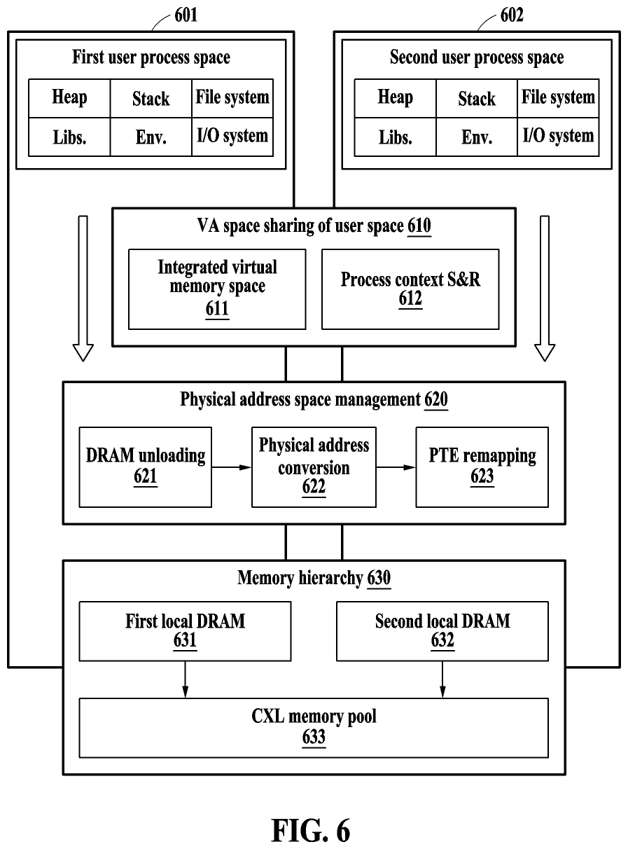

FIG. 6 illustrates an architecture of process migration, according to one or more embodiments.

Referring to FIG. 6, the architecture may include VA space sharing 610 of user space, physical address space management 620, and a memory hierarchy 630. Process migration (e.g., container migration) may be performed or controlled by an electronic device (e.g., the electronic device of FIG. 8) between a source node 601 and a target node 602. In some implementations, the controlling electronic device may be the source node 601, the target node 602, any CXL node, a CXL controller, as non-limiting examples. Each of the source node 601 and the target node 602 may include their own first user process space and their own second user process space. Each first user process space and each second user process space may include a heap, a library that manages heap memory, a stack memory, an environment corresponding to the stack memory, a file system, and an input/output system.

The VA space sharing 610 of user space involves managing an integrated virtual memory space 611 and process context saving and restoring (S&R) 612 (process context being the context of a process). For example, the VA space sharing 610 of user space may involve hooking, managing, and recording all memory calls related to a process and cloning a VA space (e.g., a second VA space) on the target node 602.

Physical address space management 620 may involve performing PTE remapping 623 based on memory unloading. Physical address space management 620 (e.g., inter-node physical address space management 620) involves physical page identification and migration by performing: DRAM unloading 621 within a local memory by using a memory unloading module (e.g., the memory unloading module 270 of FIG. 2); physical address conversion 622 of a shared page (e.g., a physical page of a CXL memory pool) within a memory pool by using an address conversion module (e.g., the address conversion module 414 of FIG. 4); and the remapping of a new physical address to a cloned virtual space within the target node 602 by using a PTE remapping module (e.g., the PTE remapping module 416 of FIG. 4).

In memory hierarchy 630, an operation of unloading or loading a physical page of the local memory to a physical page of a CXL memory pool 633 or an operation of loading a physical page of the CXL memory pool 633 to a physical page of the local memory may be performed. In memory hierarchy 630, an operation of unloading a physical page of a first local DRAM 631 of the source node 601 to a physical page of the CXL memory pool 633 may be performed, or an operation of unloading a physical page of a second local DRAM 632 of the target node 602 to a physical page of the CXL memory pool 633 may be performed. Unnecessary data movement during migration may be minimized through the operations performed in memory hierarchy 630.

FIG. 7 illustrates a process migration device according to one or more embodiments.

Referring to FIG. 7, a process migration device 700 may include a source node 701 and a target node 702. The process migration device 700 may additionally include other components, and at least one of the components included in the process migration device 700 may be combined or separated. The operations of the process migration device 700 may be performed by the electronic device (e.g., the electronic device 800 of FIG. 8) described herein.

The source node 701 may be arranged to downgrade a physical page in a local memory (the physical page corresponding to a process) to a physical page of a CXL memory pool having a first physical address. The first physical address may be based on a physical address encoding rule of the source node 701.

The target node 702 may be arranged to reconstruct a first VA space (of the source node 701) as a second VA space, determine a second physical address of a physical page in the CXL memory pool, and map the second physical address to the second VA space. The CXL memory pool may be shared by the source node 701 and the target node 702. The second VA space may be a reconstruction of the first VA space corresponding to the process of the source node 701. The second physical address may be based on a physical address encoding rule of the target node 702.

The source node 701 may be configured to identify a physical page of the local memory corresponding to a virtual page of the source node 701 based on a first page table indicating a correspondence or association between the virtual page of the source node 701 and the physical page of the local memory of the source node 701.

The source node 701 may be configured to transmit metadata including information on the first VA space to the target node 702, and the target node 702 may be arranged to reconstruct the first VA space as the second VA space based on the metadata received from the source node 701.

The second VA space may include a virtual page address dividing a virtual memory area of the target node 702 and may not include physical page information on the target node 702.

The source node 701 may be configured to transmit metadata including the information on the first VA space to the target node 702, and the target node 702 may be configured to reconstruct the first VA space as the second VA space based on the metadata received from the source node 701.

The second VA space may include a virtual page address dividing a virtual memory area of the target node 702 and may not include physical page information on the target node 702.

The target node 702 may be configured to reconstruct the second physical address based on information on the first physical address and the physical address encoding rule of the target node 702.

The target node 702 may be configured to map the second physical address to the second VA space by filling the second physical address into a second page table.

The information on the first physical address may include information on an offset corresponding to the first physical address of a physical page of the CXL memory pool.

The target node 702 may be configured to determine whether to upgrade/move/migrate a physical page in the CXL memory pool to a physical page of the local memory of the target node 702, based on the frequency of access to the physical page in the CXL memory pool.

The target node 702 may be configured to upgrade the physical page in the CXL memory pool to the physical page of the local memory of the target node 702 if the frequency of access to the physical page in the CXL memory pool exceeds a threshold value.

FIG. 8 illustrates an electronic device according to one or more embodiments.

Referring to FIG. 8, the electronic device 800 (e.g., the process migration device 700 of FIG. 7) may include a memory 810 and a processor 820.

The memory 810 may store instructions (e.g., code) and a computer program executable by the processor 820. The memory 810 may store the instructions executable by the processor 820. When executed by the processor 820, the instructions executable by the processor 820 may cause the processor 820 to perform a migration method. The memory 810 may be integrated with the processor 820. For example, RAM or flash memory may be arranged in an integrated circuit microprocessor. In addition, the memory 810 may include a separate device, such as a storage device that may be used by an external disk drive, a storage array, or a database system. The memory 810 and the processor 820 may be operatively integrated or may allow the processor 820 to read a file stored in the memory 810 by communicating with each other via an I/O port or a network connection. The memory 810 may be a non-transitory computer-readable storage medium that stores instructions and, when the instructions are executed by the processor 820, the instructions stored in the memory 810 may prompt at least one processor 820 to execute the migration method.

The non-transitory computer-readable storage medium may include read-only memory (ROM), programmable ROM (PROM), electrically erasable PROM (EEPROM), RAM, dynamic RAM (DRAM), static RAM (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, BLU-RAY or optical disk memory, hard disk drive (HDD), solid-state drive (SSD), card memory (e.g., a multimedia card, a secure digital (SD) card, or an extreme digital (XD) card), magnetic tape, floppy disk, a magneto-optical data storage device, an optical data storage device, and other devices, but not a signal per se.

For example, the processor 820 may execute the instructions/code stored in the memory 810. The processor 820 may include a central processing unit (CPU), a graphics processing unit (GPU), a neural network processing unit (NPU), a media processing unit (MPU), a data processing unit (DPU), a vision processing unit (VPU), a video processor, an image processor, a display processor, a microprocessor, a processor core, a multi-core processor, an application-specific integrated circuit (ASIC), a field programmable gate array (FPGA), or any combination thereof.

When the instructions are executed by the processor 820, the processor 820 may control a source node to downgrade a physical page in a local memory corresponding to the process to a physical page of a CXL memory pool having a first physical address, control a target node to reconstruct a first VA space as a second VA space, determine a second physical address of the physical page in the CXL memory pool, and control the target node to map the second physical address to the second VA space. The CXL memory pool may be shared by the source node and the target node, the second VA space may correspond to a first VA space corresponding to the process of the source node, the first physical address may be based on a physical address encoding rule of the source node, and the second physical address may be based on a physical address encoding rule of the target node.

When the instructions are executed by the processor 820, the processor 820 may control the source node to identify a physical page of a local memory corresponding to a virtual page of the source node based on a first page table indicating a correspondence between the virtual page of the source node and the physical page of the local memory of the source node.

When the instructions are executed by the processor 820, the processor 820 may control the source node to transmit metadata including information on the first VA space to the target node and may control the target node to reconstruct the first VA space as the second VA space based on the metadata received from the source node.

The second VA space may include a virtual page address dividing a virtual memory area of the target node and may not include physical page information on the target node.

When the instructions are executed by the processor 820, the processor 820 may control the target node to reconstruct the second physical address based on information on the first physical address and the physical address encoding rule of the target node.

The information on the first physical address may include information on an offset corresponding to the first physical address of a physical page of the CXL memory pool.

When the instructions are executed by the processor 820, the processor 820 may control the target node to map the second physical address to the second VA space by filling the second physical address into a second page table.

When the instructions are executed by the processor 820, the processor 820 may control the target node to determine whether to upgrade a physical page of the CXL memory pool to a physical page of a local memory of the target node, based on the frequency of access to the physical page in the CXL memory pool.

When the instructions are executed by the processor 820, the processor 820 may control the target node to upgrade the physical page in the CXL memory pool to the physical page of the local memory of the target node if the frequency of access to the physical page in the CXL memory pool exceeds a threshold value.

The units described herein may be implemented using a hardware component, a software (code/instructions) component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

The computing apparatuses, the electronic devices, the processors, the memories, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device configured to perform at least part of migration of a process from a source node to a target node, the electronic device comprising:
a memory storing instructions; and
one or more processors configured to execute the instructions,
wherein the instructions, when executed by the one or more processors, cause the electronic device to control:
the source node to downgrade a physical page in a local memory corresponding to the process to a physical page of a compute express link (CXL) memory pool having a first physical address, the source node having a first virtual address space corresponding to the process; and
the target node to reconstruct the first virtual address space as a second virtual address space, determine a second physical address of the physical page in the CXL memory pool and map the second physical address to the second virtual address space,
wherein the CXL memory pool is shared by the source node and the target node,
the first physical address is determined based on a physical address encoding rule of the source node, and
the second physical address is determined based on a physical address encoding rule of the target node.

2. The electronic device of claim 1, wherein the instructions, when executed by the one or more processors, cause the source node to
identify the physical page of the local memory corresponding to virtual page of the source node based on a first page table indicating a correspondence between the virtual page of the source node and the physical page of the local memory of the source node.

3. The electronic device of claim 1, wherein, based on the control of the electronic device:
the source node transmits metadata comprising information on the first virtual address space to the target node, and
the target node reconstructs the first virtual address space as the second virtual address space based on the metadata received that the target node receives from the source node.

4. The electronic device of claim 3, wherein the second virtual address space comprises a virtual page address dividing a virtual memory area of the target node and does not comprise physical page information on the target node.

5. The electronic device of claim 1, wherein based on the control of the electronic device,
the target node reconstructs the second physical address based on information on the first physical address and the physical address encoding rule of the target node.

6. The electronic device of claim 5, wherein the information on the first physical address comprises
information on an offset corresponding to the first physical address of a physical page of the CXL memory pool.

7. The electronic device of claim 1, wherein based on the control of the electronic device,
the target node maps the second physical address to the second virtual address space by filling the second physical address into a second page table.

8. The electronic device of claim 1, wherein based on the control of the electronic device,
the target node determines whether to upgrade a physical page of the CXL memory pool to a physical page of a local memory of the target node, based on a frequency of access to the physical page in the CXL memory pool.

9. The electronic device of claim 8, wherein based on the control of the electronic device,
the target node upgrades the physical page in the CXL memory pool to the physical page of the local memory of the target node based on the frequency of access to the physical page in the CXL memory pool exceeding a threshold value.

10. A migration method performed by based on control of an electronic device, the migration method comprising, based on the control of the electronic device:
downgrading, by a source node, a physical page in a local memory corresponding to a process to a physical page of a compute express link (CXL) memory pool having a first physical address, the source node having a first virtual address space corresponding to the process;
reconstructing, by a target node, the first virtual address space as a second virtual address space;
determining, by the target node, a second physical address of the physical page in the CXL memory pool; and
mapping, by the target node, the second physical address to the second virtual address space,
wherein the CXL memory pool is shared by the source node and the target node,
the first physical address is based on a physical address encoding rule of the source node, and
the second physical address is based on a physical address encoding rule of the target node.

11. The migration method of claim 10, wherein the source node identifies the physical page of the local memory corresponding to a virtual page of the source node based on a first page table indicating a correspondence between the virtual page of the source node and the physical page of the local memory of the source node.

12. The migration method of claim 10, further comprising:
transmitting, by the source node, metadata comprising information on the first virtual address space to the target node, and
the reconstructing the first virtual address space as the second virtual address space by the target node is based on the metadata that the target node receives from the source node.

13. The migration method of claim 12, wherein the second virtual address space comprises a virtual page address dividing a virtual memory area of the target node and does not comprise physical page information on the target node.

14. The migration method of claim 10, wherein the target node reconstructs the first virtual address space as the second physical address based on information on the first physical address and the physical address encoding rule of the target node.

15. The migration method of claim 14, wherein the information on the first physical address comprises
information on an offset corresponding to the first physical address of a physical page of the CXL memory pool.

16. The migration method of claim 10, wherein the target node maps the second physical address to the second virtual address space by filling the second physical address into a second page table.

17. The migration method of claim 10, wherein the target node determines whether to upgrade a physical page of the CXL memory pool to a physical page of a local memory of the target node, based on a frequency of access to the physical page in the CXL memory pool.

18. The migration method of claim 17, wherein the target node upgrades the physical page in the CXL memory pool to the physical page of the local memory of the target node based on the frequency of access to the physical page in the CXL memory pool exceeding a threshold value.

19. The migration method of claim 10, wherein the downgrading, by the source node, the physical page in the local memory corresponding to the process to the physical page of the compute express link (CXL) memory pool having the first physical address comprises: moving the physical page from the local memory to the CXL memory pool.

20. A non-transitory computer-readable storage medium storing instructions that, when executed by a processor, cause the processor to perform the migration method of claim 10.
